(19) United States
(12) Patent Application Publication
(10) Pub. No.: US 2014/0184603 A1
(43) Pub. Date: Jul. 3, 2014

(54) METHOD TO IMPROVE USABILITY OF HIGH PIXEL DENSITY DISPLAYS

(71) Applicant: NVIDIA CORPORATION, Santa Clara, CA (US)

(72) Inventor: Rambod Jacoby, San Jose, CA (US)

(73) Assignee: NVIDIA CORPORATION, Santa Clara, CA (US)

(21) Appl. No.: 13/728,207

(22) Filed: Dec. 27, 2012

(51) Int. Cl. G06T 3/40

(52) U.S. Cl. CPC G06T 3/40
USPC 345/428

(57) ABSTRACT

A system and method of scalable resolution display are presented. Embodiments of the present invention are operable to partition the native resolution (e.g., available pixel density) of a high pixel density display screen into multiple display regions (windows) in a manner such that each partitioned display region is capable of independently displaying scaled output with respect to its allotted native resolution. As such, both high pixel count images and “low” pixel count images may be displayed simultaneously within the same high pixel density display screen in a manner that enhances the user's visual experience.

### FIELD OF THE INVENTION

Embodiments of the present invention are generally related to the field of display devices.

### BACKGROUND OF THE INVENTION

Within the display industry, there is a growing trend in developing high resolution display screens (e.g., 3840×2160 native resolution display screens). Significantly, this trend focuses on technologies which increase pixel densities to improve the native resolution of these display screens, especially for the smaller display screens found on mobile devices. Creating display screens in this manner provides a substantial advantage in that they increase the sharpness of various forms of media that may be displayed, including text and digital photography, by eliminating the visual perception of pixels.

However, as pixel density is increased, the user may also experience residual effects which may significantly impact the user's overall visual experience. For example, increasing pixel densities may give the user the perception that objects commonly found a user's desktop (e.g., icons, toolbars, etc.) look smaller, particularly on large display screens (e.g., 17-inch display screens). Also, when reading textual content (e.g., application menus) using such technologies, the user may experience visual discomfort due to the text appearing smaller. Although conventional methods attempt to resolve these issues by changing the resolution of the entire display screen to make content displayed appear larger, these methods generally only provide a temporary solution and often require cumbersome efforts on the part of the user to utilize and apply over the entire screen.

### SUMMARY OF THE INVENTION

Accordingly, a need exists to address the inefficiencies discussed above. Embodiments of the present invention are operable to partition the native resolution (e.g., available pixel density) of a high pixel density display screen into multiple display regions (windows) in a manner such that each partitioned display region is capable of independently displaying scaled output with respect to its allotted native resolution. As such, both high pixel count images and “low” pixel count images may be displayed simultaneously within the same high pixel density display screen in a manner that enhances the user's visual experience. In effect, embodiments of the present invention allow a display screen to be divided into multiple regions, where each region can have its own resultant resolution that can be different from other regions.

More specifically, in one embodiment, the present invention is implemented as a method of displaying content simultaneously on a single display screen. In one embodiment, the single display screen is a high pixel density display screen. The method includes accessing a definition of a set of coordinates for each display region of a plurality of display regions located within the single display screen, in which the single display screen comprises a native resolution value in which each display region also has a subset resolution value of the native resolution value for each display region producing a plurality of subset resolution values, in which the plurality of subset resolution values comprise at least two different values.

In one embodiment, the set of coordinates for a given display region is defined subsequent to an execution of an application associated with the given display region. The method also includes scaling pixel data associated with content for display for each display region of the plurality of display regions producing a scaled output, the scaling using a scaling module as well as rendering the scaled output separately for each display region on the single display screen. The method of scaling further includes adjusting the pixel data with respect to the subset resolution value associated with each display region and the set of coordinates associated with the display region. In one embodiment, the amount of scaling depends on: (1) the native resolution of the screen and (2) the subset resolution. In one embodiment, the plurality of subset resolution values is user-defined.

In one embodiment, the plurality of display regions is configured to display different content of a same application within the single display screen. In one embodiment, the plurality of display regions is configured to display different content from different applications within the single display screen. In one embodiment, an application configured to operate using a defined resolution value is operable to automatically launch within a display region of the plurality of display regions upon execution of the application.

In another embodiment, the present invention is implemented as a system for displaying content simultaneously on a single display screen. The system includes a display unit coupled to the single display screen, in which the display unit is operable to display a plurality of display regions on the single display screen, in which the single display screen comprises a native resolution value. In one embodiment, the single display screen is a high pixel density display screen.

The system includes a coordinate module operable to access a definition of a set of coordinates for each display region of the plurality of display regions within the single display screen and a subset resolution value of the native resolution value for each display region producing a plurality of subset resolution values, in which the plurality of subset resolution values comprise at least two different values.

The system also includes a scaling module operable to scale pixel data associated with content for display for each display region of the plurality of display regions producing a scaled output as well as a rendering module operable to render the scaled output separately for each display region on the single display screen. In one embodiment, the scaling module is further operable to adjust the pixel data with respect to the subset resolution value associated with each display region and the set of coordinates associated with the display region. In one embodiment, the set of coordinates for a given display region is defined subsequent to an execution of an application associated with the given display region. In one embodiment, the plurality of subset resolution values is user-defined.

In one embodiment, the plurality of display regions is configured to display different content of a same application within the single display screen. In one embodiment, the plurality of display regions is configured to display different content from different applications within the single display screen. In one embodiment, an application configured to operate using a defined resolution value is operable to automatically launch within a display region of the plurality of display regions upon execution of the application.

In yet another embodiment, the present invention is implemented as a method of displaying content simultaneously on a single display screen coupled to a remote client device. In one embodiment, the single display screen is a high pixel density display screen. The method includes receiving a definition of a set of coordinates from the remote client device over a communication network for each display region of a plurality of display regions located within the single display screen, in which the single display screen comprises a native resolution value, and a subset resolution value of the native resolution value for each display region producing a plurality of subset resolution values, in which the plurality of subset resolution values comprise at least two different values.

In one embodiment, the set of coordinates for a given display region is defined subsequent to an execution of an application associated with the given display region. The method also includes scaling pixel data associated with content for display for each display region of the plurality of display regions producing a scaled output using a host device as well as, using the host device, transmitting the scaled output separately for each display region on the single display screen coupled to the remote client device over the communication network. The method of scaling further includes adjusting the pixel data with respect to the subset resolution value associated with each display region and the set of coordinates associated with the display region. In one embodiment, the amount of scaling depends on: (1) the native resolution of the screen and (2) the subset resolution. In one embodiment, the plurality of subset resolution values is user-defined.

In one embodiment, the plurality of display regions is configured to display different content of a same application within the single display screen coupled to the remote client device. In one embodiment, the plurality of display regions is configured to display different content from different applications within the single display screen coupled to the remote client device. In one embodiment, an application configured to operate using a defined resolution value is operable to automatically launch within a display region of the plurality of display regions upon execution of the application.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A is a block diagram of an exemplary display system capable of implementing a method of scalable resolution display in accordance with embodiments of the present invention.

FIG. 1B is a flowchart of an exemplary method of selective scaling on high pixel density display in an embodiment according to the present invention.

FIG. 1C is another flowchart of an exemplary method of selective scaling on high pixel density display in an embodiment according to the present invention

FIG. 2 presents an illustration of an exemplary on-screen result of a method of scalable resolution display in accordance with embodiments of the present invention.

FIG. 3 presents an illustration of an exemplary on-screen result of a method of scalable resolution display in accordance with embodiments of the present invention.

FIG. 4A presents an illustration of a network communication between a remote client device and a host device implementing a method of scalable resolution display in accordance to embodiments of the present invention.

FIG. 4B is a flowchart of an exemplary method of network communication between a remote client device and a host device implementing a method of scalable resolution display in accordance to embodiments of the present invention.

FIG. 4C is another flowchart of an exemplary method of network communication between a remote client device and a host device implementing a method of scalable resolution display in accordance to embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### Exemplary Display System

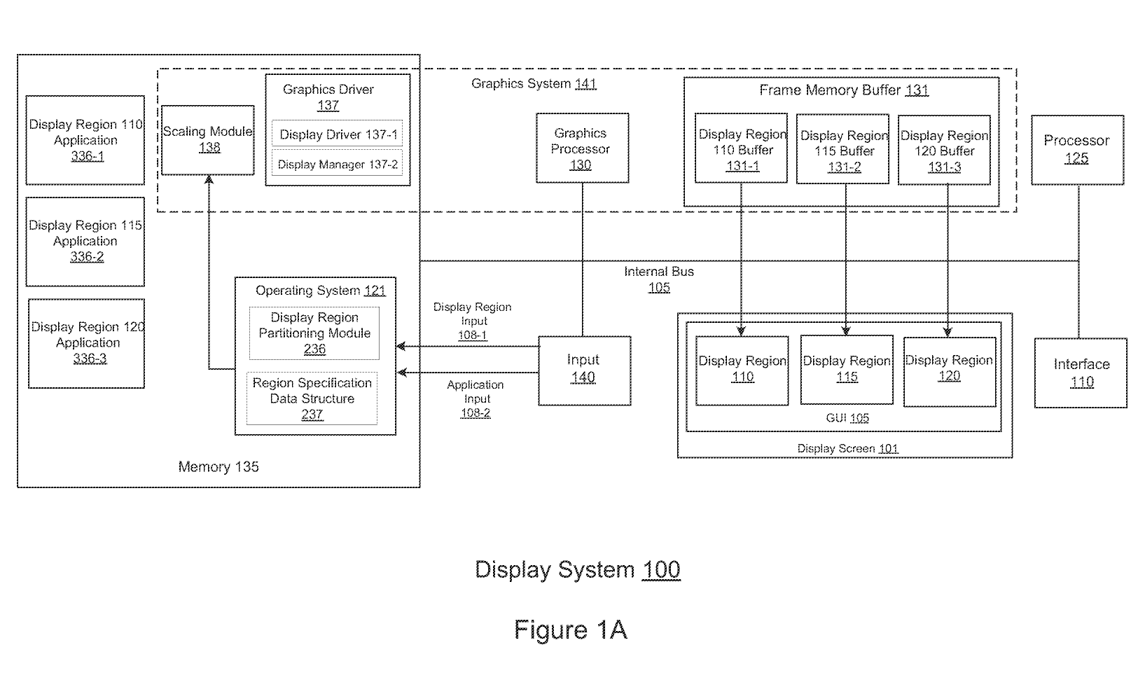

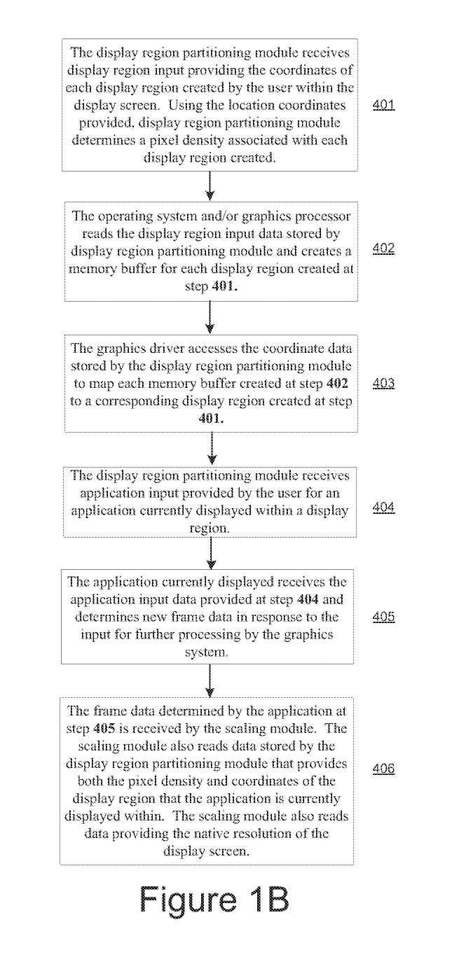

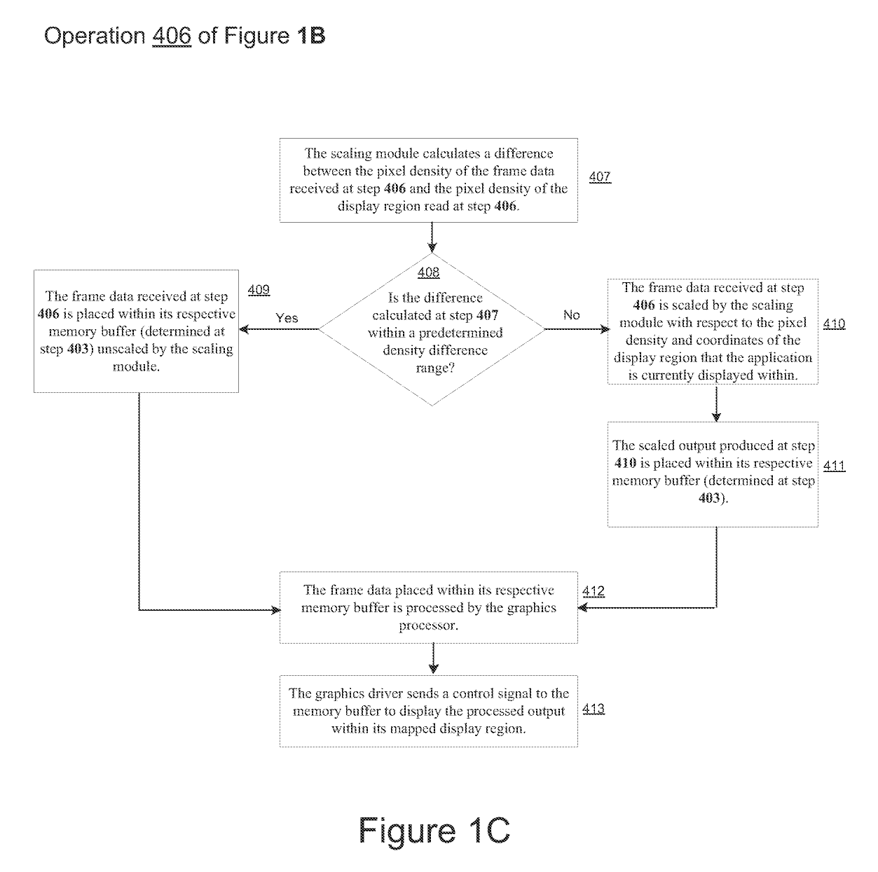

As presented in FIG. 1A, an exemplary display system 100 upon which embodiments of the present invention may be implemented is depicted. Display system 100 may be implemented as any device capable of rendering content to a visual display such as a mobile device, laptop, desktop computer, server, or the like. Display screen 101 may be a device capable of displaying images having higher pixel counts. Furthermore, display screen 101 is operable to display a graphical user interface (e.g., GUI 105) capable of allowing a user to interact with various components of display system 100. GUI 105 may display multiple display regions (e.g., display regions 110, 115 and 120) partitioned within display screen 101 in a manner such that each display region is allotted a section or region of the available pixel density (e.g., native resolution) of display screen 101.

In addition to storing values associated with the available pixel density of display screen 101, display region partitioning module 236 may also store values received from display region input 108-1 and application input 108-2 provided by the user through input 140. In one embodiment, display region input 108-1 may include coordinate data providing the dimensions of each display region created within GUI 105 by the user. Based on this coordinate data, display region partitioning module 236 may be operable to determine the available pixel density of the display regions created. In one embodiment, display region partitioning module 236 may be operable to determine by itself or receive data from another component within display system 100 regarding the native resolution of a display screen (e.g., data regarding the native resolution of display screen 101). In one embodiment, application input 108-2 may be user-provided input for an application currently displayed within a particular display region (e.g., application 336-1, application 336-2 and application 336-3). Furthermore, display region definition data may be stored in region specification data structure 237. In one embodiment, region specification data structure 237 may store region identification numbers, display region coordinate boundaries (x,y), as well as a resolution associated with each display region. The user may define the display region boundaries using input 140, which may be coupled to GUI 105. Input 140 may include devices that are operable communicate user inputs from one or more users to display system 100 and may include keyboards, mice, joysticks, touch screens, and/or microphones.

Based on the display region input 108-1 received from display region partitioning module 236, operating system 121 and/or graphics processor 130 may create additional memory buffers within frame memory buffer 131 so that graphics processor 130 may process pixel data independently for each respective display region. In one embodiment, each display region may have its own memory buffer created for processing output images for display within that particular display region (e.g., buffers 131-1, 131-2 and 131-3). In another embodiment, frame memory buffer 115 and/or other memory may be part of memory 135 which may be shared with processor 125 and/or graphics processor 130.

Graphics system 141 may be operable to render output for each display region created based on data provided by display region input 108-1 and application input 108-2. In one embodiment, graphics system 141 may comprise graphics driver 137, graphics processor 130, frame memory buffer 115 and scaling module 138. Graphics driver 137 may be used to configure graphics processor 130. In one embodiment of the present invention, graphics driver 137 may comprise display driver 137-1 and display manager 137-2. In one embodiment, display manager 137-2 may be operable to read display region input 108-1 stored by display region partitioning module 236 and map an application to a display region created (e.g., application 336-1, application 336-2 and application 336-3). Based on the mapping determinations made by display manager 137-2, data generated by an application in response to user input (e.g., application input 108-2 stored by display region partitioning module 236) may be sent to their respective memory buffers (e.g., buffers 131-1, 131-2 and 131-3) for further processing by graphics processor 130.

In one embodiment, scaling module 138 may be operable to read data stored by display region partitioning module 236 to determine the pixel densities and coordinates corresponding to various display regions created by a user. Scaling module 138 may also receive data providing information regarding the native resolution capabilities of display screen 101 via display region partitioning module 236. Additionally, scaling module 138 may be operable to determine the pixel densities of frames issued by applications stored in memory 135. When performing scaling operations, according to one embodiment, scaling module 138 may be operable to make comparisons between the pixel densities of the display regions created by the user and the pixel densities of frame data issued by applications. In one embodiment, based on the comparison, scaling module 138 may be operable to adjust the resolution, size and/or color of pixel data associated with a frame issued by an application stored in memory 135 (e.g., application 336-1, application 336-2 and application 336-3). In one embodiment, scaling module 138 and/or graphics processor 130 may be operable to perform additional spatial anti-aliasing operations on the pixel data in order to minimize any distortion or shading inconsistencies that may affect the resultant scaled output.

Within a memory buffer created for a particular display region, graphics processor 130 may generate pixel data for output images associated with an application mapped to that display region using rendering commands provided the application. In one embodiment, display system 100 may include additional physical graphics processors, each configured similarly to graphics processor 130. These additional graphics processors may be configured to operate in parallel with graphics processor 130 to simultaneously generate pixel data for different portions of an output image, or to simultaneously generate pixel data for different output images. Furthermore, display driver 137-1 may be operable to send control signals to each memory buffer created to transmit their respective output for display within their respective display regions.

FIG. 1B provides a flow chart of an exemplary method of selective scaling on high pixel density display in accordance with embodiments of the present invention. FIG. 1B depicts how embodiments of the present invention are operable to receive display region input and application input using a module within the operating system prior to performing scaling operations in accordance with embodiments of the present invention.

At step 401, the display region partitioning module receives display region input providing the coordinates of each display region created by the user within the display screen. Using the location coordinates provided, display region partitioning module determines a pixel density associated with each display region created.

At step 402, the operating system and/or graphics processor reads the display region input data stored by display region partitioning module and creates a memory buffer for each display region created at step 401.

At step 403, the graphics driver accesses the coordinate data stored by the display region partitioning module to map each memory buffer created at step 402 to a corresponding display region created at step 401.

At step 404, the display region partitioning module receives application input provided by the user for an application currently displayed within a display region.

At step 405, the application currently displayed receives the application input data provided at step 404 and determines new frame data in response to the input for further processing by the graphics system.

At step 406, the frame data determined by the application at step 405 is received by the scaling module. The scaling module also reads data stored by the display region partitioning module that provides both the pixel density and coordinates of the display region that the application is currently displayed within. The scaling module also reads data providing the native resolution of the display screen (e.g., display screen 101).

FIG. 1C presents a flowchart which describes exemplary operations in accordance with the various embodiments herein described. FIG. 1C depicts how embodiments of the present invention are operable to perform scaling operations on frame data received by the scaling module in accordance with embodiments of the present invention. The details of operation 406 (see FIG. 1B) are outlined in FIG. 1C.

At step 407, the scaling module calculates a difference between the pixel density of the frame data received at step 406 and the pixel density of the display region read at step 406.

At step 408, a determination is made as to whether the difference calculated at step 407 is within a predetermined density difference range. If the difference is within the predetermined density difference range, then the scaling module will not perform scaling operations on the frame data, as detailed in step 409. If the difference is not within the predetermined density difference range, then the scaling module will perform scaling operations on the frame data, as detailed in step 410.

At step 409, the difference is within the predetermined density difference range, therefore, the frame data received at step 406 is placed within its respective memory buffer (determined at step 403) unscaled by the scaling module.

At step 410, the difference is not within the predetermined density difference range, therefore, the frame data received at step 406 is scaled by the scaling module with respect to the pixel density and coordinates of the display region that the application is currently displayed within. The scaling module may adjust the resolution, size, and/or color of the pixel data associated with the frame received. Furthermore, the scaling module may perform these operations using the native resolution of the display screen.

At step 411, the scaled output produced at step 410 is placed within its respective memory buffer (determined at step 403).

At step 412, frame data placed within its respective memory buffer is processed by the graphics processor.

At step 413, the graphics driver sends a control signal to the memory buffer to display the output within its mapped display region.

### Exemplary Method of Selective Scaling on High Pixel Density Display

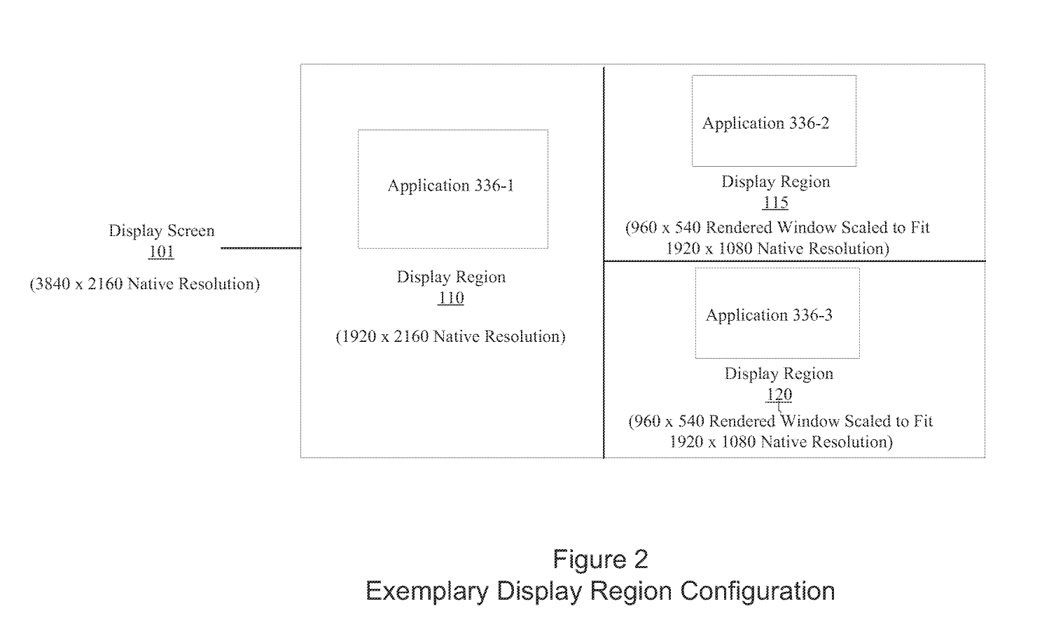

FIG. 2 presents exemplary display screen 101 capable of displaying images having higher pixel counts in an embodiment of the present invention. FIG. 2 depicts display screen 101 as having a 3840×2160 native resolution display (e.g., available pixel density of display screen 101). In one embodiment, with reference to FIG. 2, display screen 101 may display three display regions configured in a manner such that each display region is allotted a section of the 3840×2160 native resolution of display screen 101. Using their respective allocated pixel densities, each display region may be configured by embodiments of the present invention to render output independently such that one display region may render output at a different resolution than output rendered within another display region. Accordingly, a user may be able to view different forms of content at different resolutions simultaneously within the same high pixel density display.

In one embodiment, before pixel data associated with an image is processed by the graphics processor for a particular display region, the scaling module may scale the pixel data in a manner such that the number of pixels comprising the image may be increased or decreased with respect to the pixel density of the display region where the image is to be rendered. As such, the scaling module may use the allocated pixel densities of a display region to increase the number of pixels associated with images having lower pixel counts displayed within high pixel density display regions. Therefore, images having lower pixel counts may be up scaled to appear bigger (e.g., making text appear bigger) within display regions having greater pixel density. At the same time, applications that produce images having higher pixel counts (e.g., applications that primarily produce high quality images) may also be displayed within high pixel density display regions. As such, the scaling module may not perform any scaling operations on pixel data associated with images having higher pixel counts displayed within these display regions, thus allowing these images to utilize the pixel density available.

With reference to FIG. 2, display region 110 may be created to have a native resolution of 1920×2160, while display region 115 and display region 120 may each be configured to have a native resolution of 1920×1080. In one embodiment, a user may place an application that produces images having higher pixel counts (e.g., image viewing/enhancement applications, etc.) for display within display region 110, thus utilizing the larger pixel surface area available. At the same time, the user may place applications that produce images with lower pixel counts (e.g., applications that primarily produce textual content) for display in either display region 115 or 120, which provide less pixel surface area compared to display region 110.

For example, based on the embodiment configurations depicted in FIG. 2, a user may place an application that primarily renders textual content (e.g., email application 336-2) within display region 115 for display. In one embodiment, using the pixel density allocated to display region 115 (1920×1080), a graphics system communicatively coupled to display screen 101 may render the output images of application 336-2 at a quarter of the native resolution of display screen 101 (960×540). Pixel data comprising images to be displayed within display region 115 may be scaled by a factor of 4× such that pixels are doubled in both width and height. Therefore, for each frame application 336-2 issues for processing by the graphics processor, the scaling module may increase the number of pixels associated with that frame vertically 2× and horizontally 2× to fit the 1920×1080 native resolution of display region 115.

Similarly, the user may simultaneously display another application that primarily renders textual content (e.g., word processing application 336-3) within display region 120. Using the pixel density allocated to display region 120 (1920×1080), a graphics system communicatively coupled to display screen 101 may also render the output images of application 336-3 at a quarter of the native resolution of display screen 101 (960×540). Pixel data comprising images to be displayed within display region 120 may be scaled by a factor of 4× such that pixels are doubled in both width and height. Therefore, for each frame application 336-3 issues for processing by the graphics processor, the scaling module may increase or upscale the number of pixels associated with that frame vertically 2× and horizontally 2× to fit the 1920×1080 native resolution of display region 120.

Additionally, the user may also simultaneously display an application that primarily renders images comprising higher pixel counts (e.g., image viewing/enhancement application 336-1) within display region 110. Therefore, pixel data comprising images associated with application 336-1 for display within display region 110 may not be scaled when using the allotted pixel density available for display region 110 (1920×2160).

Although FIG. 2 depicts an embodiment using an even numbered scaling factor (e.g., scaling factor of 4×), embodiments of the present invention are not limited to such. Furthermore, in one embodiment, the user may determine a scaling factor based on user preferences.

In another embodiment of the present invention, the user may define resolution settings for an application such that, when executed, the application is launched into a partitioned display region based on predefined resolution settings. In these scenarios, embodiments of the present invention offer the advantage of not requiring the user to manually place an application within a defined display region every time the application is executed. Such an embodiment may be particularly useful for applications that are frequently used by the user.

In one embodiment, once the user sets the resolution settings, the application may communicate this information to a module within an operating system that stores display region details regarding each partitioned display region created by the user. For instance, in one embodiment, if the user configures application 336-1 to execute using a resolution of 1920×2160, application 336-1 may communicate these settings to the operating system which may then launch application 336-1 upon execution within display region 110 after retrieving details regarding the configurations of the defined display regions from the display region partitioning module. In one embodiment, operating system 121 may search through all of the display regions created by the user when locating the display region that satisfies the resolution settings requested by application 336-1 before making the determination that application 336-1 should be launched within display region 110. Additionally, the user may configure applications 336-2 and 336-3 in a similar manner such that they launch within display regions 115 and 120 respectively upon execution.

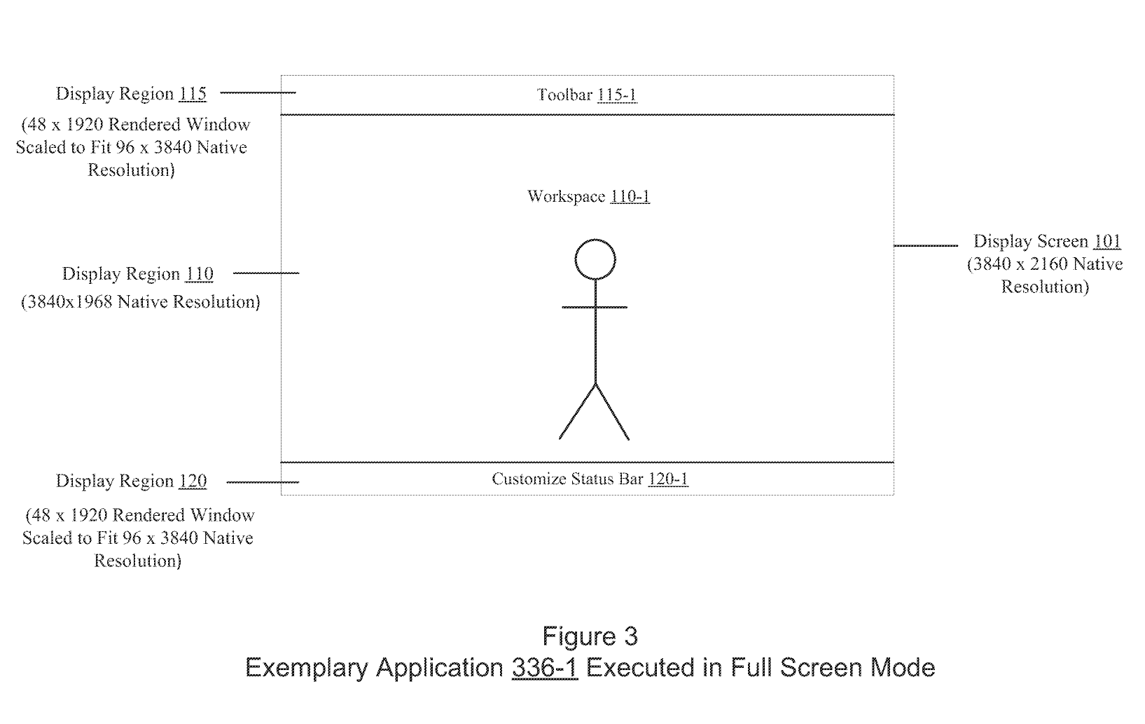

FIG. 3 presents another exemplary display screen capable of displaying images having higher pixel counts in an embodiment of the present invention. Similar to embodiments described herein, FIG. 3 depicts display screen 101 as having a 3840×2160 native resolution display (e.g., available pixel density of display screen 101). FIG. 3 depicts an embodiment in which the user executes a single application in full-screen mode prior to defining the display regions so that the user may subsequently adjust the display regions in a dynamic manner so as to position specific elements of the application that may better utilize the high resolution capabilities of display screen 101. Application 336-1 (e.g., image viewing/enhancement application) may be comprised of three main visual elements: toolbar 115-1, workspace 110-1 and “customize status” bar 120-1. In one embodiment, the user may first execute application 336-1 in full-screen mode, thus, displaying the application in a manner that utilizes the complete 3840×2160 native resolution of display screen 101 (e.g., utilizing the available pixel density for display screen 101).

After executing application 336-1 in full screen mode, the user may subsequently decide that workspace 110-1 may better utilize the high resolution capabilities of display screen 101, whereas toolbar 115-1 and customize status bar 120-1 may cause the user discomfort if displayed at such a resolution. Accordingly, display region 110 may be partitioned to display workspace 110-1, thus allotting workspace 110-1 to have a native resolution of 3840×1968 (e.g., utilizing the available pixel density for display region 110). Furthermore, display regions 115 and 120 may also be subsequently configured in a manner that allots a native resolution of 96×3840 for both display region 115 and display region 120.

Based on the coordinates of display region 115 and display region 120, the graphics system may render the output images of each display region at a quarter of the native resolution of display screen 101 (48×1920). Therefore, pixel data comprising images associated with toolbar 115-1 and customize status bar 120-1 may be scaled by a factor of 4× such that their respective pixels are doubled in width and height and then scaled to fit their respective 96×3840 native resolutions within display regions 115 and 120. Simultaneously, based on the coordinates of display region 110, the graphics system may render the output images related to workspace 110-1 using the native resolution of display region 110 (3840×1968). Therefore, high pixel count images displayed within display region 110 may not be scaled so that they may use the allotted 3840×1968 native resolution for display region 110.

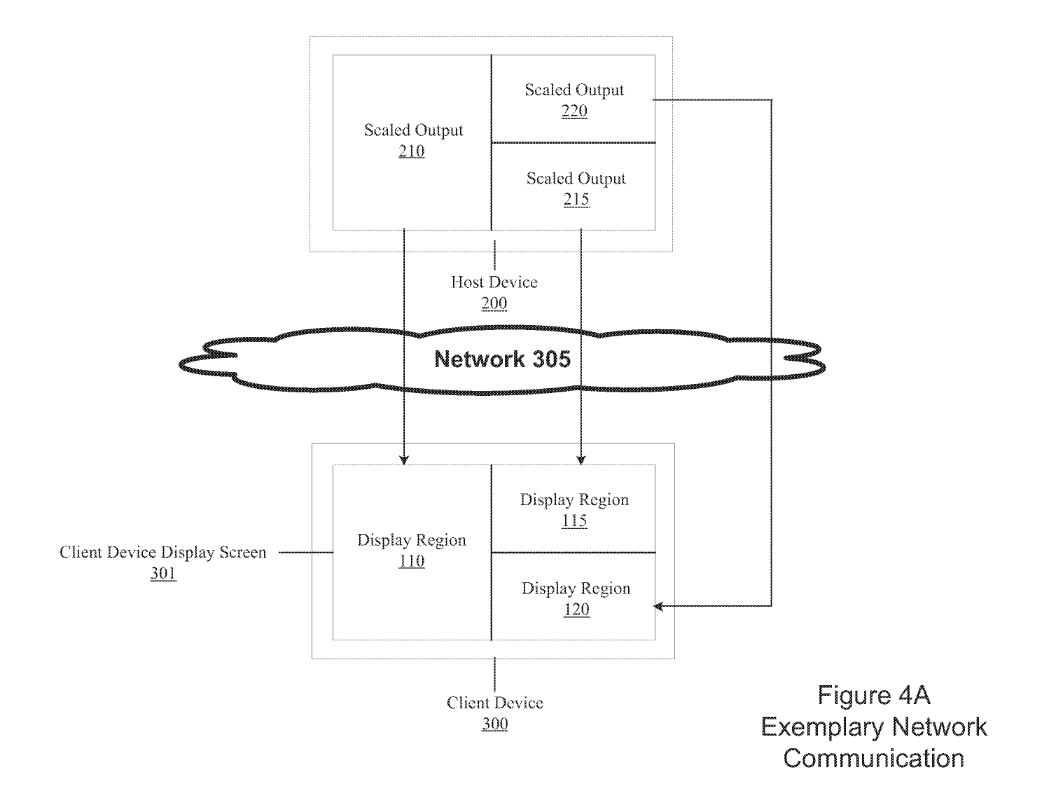

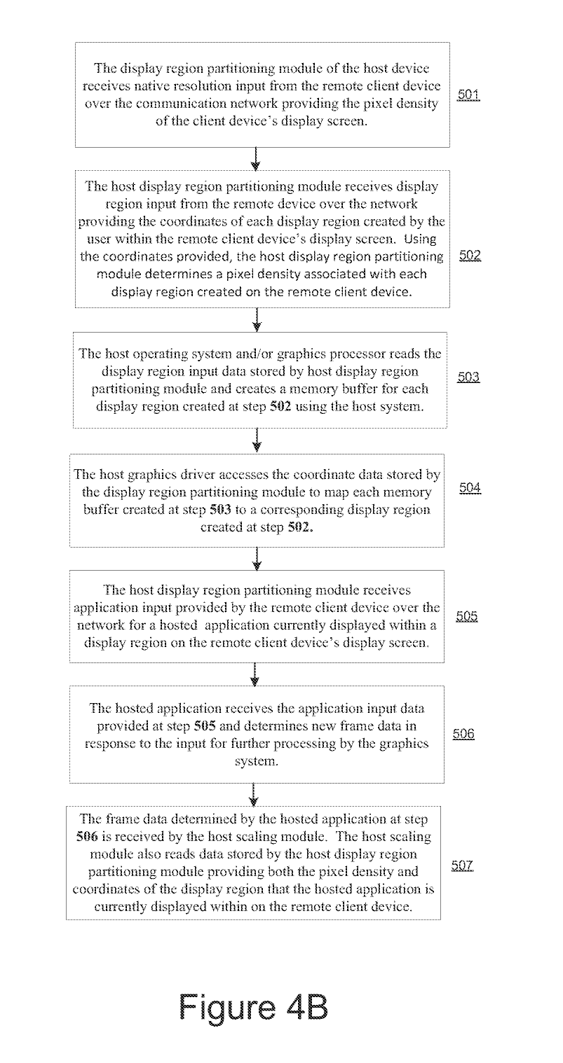

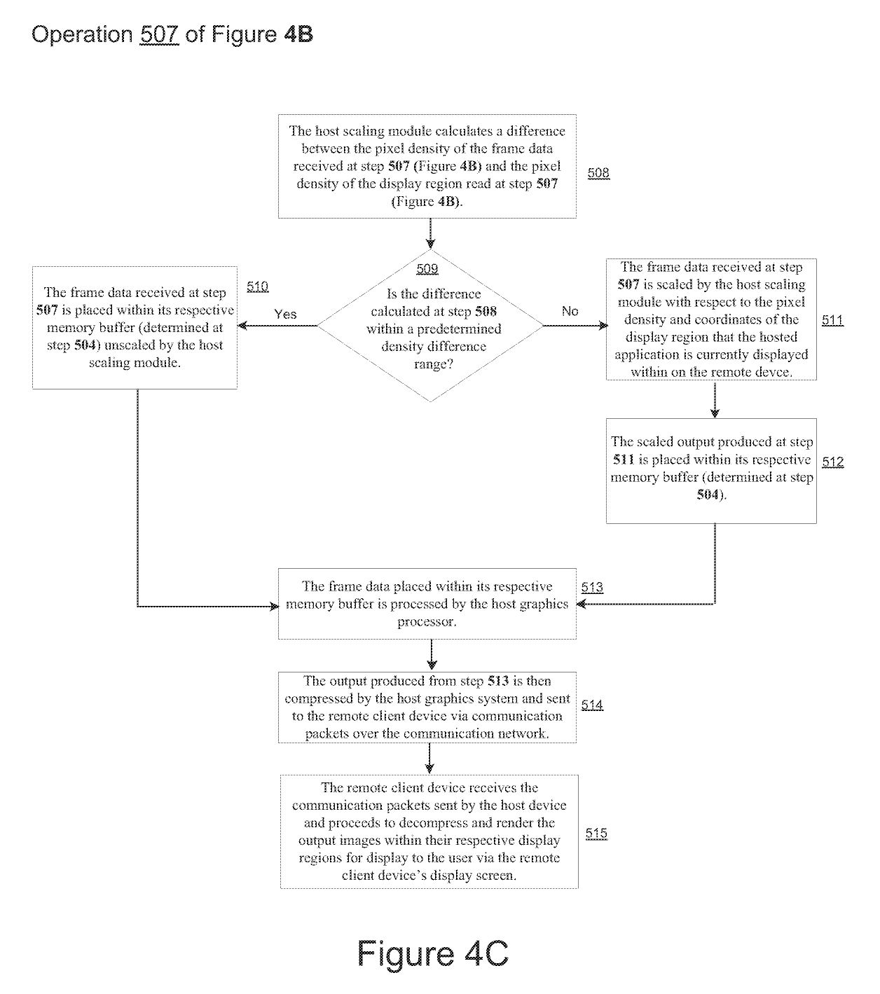

FIG. 4A provides an exemplary network communication between a host device and a remote client device in accordance with embodiments of the present invention. FIG. 4A illustrates how a host device may be operable to provide scaled content to a remote client device coupled to a high pixel density display screen in accordance with various embodiments described herein. FIG. 4A depicts an embodiment in which a host graphics system (e.g., similar to graphics system 141) may be operable to provide scaled application data for display regions partitioned on a remote client device over a communication network. Therefore, embodiments of the present invention may allow a user to receive different forms of hosted content over a communication network at different resolutions simultaneously within the same high pixel density display in a manner similar to embodiments described herein.

In scaling output data for each of the display regions of client device 300, the host graphics system may be operable to receive input data from client device 300 over network 305. In one embodiment, input data may include data regarding the native resolution capabilities of client device display screen 301. Host device 200 may also receive input data (e.g., display region input 108-1) that may include coordinate data providing the dimensions of each display region partitioned within client device display screen 301 by the user. Furthermore, the input data may also provide application input (e.g., application input 108-2) for an application configured to be associated with a particular display region (e.g., display regions 110, 115 and 120 of client device display screen 301). In one embodiment, client device 300 may use an application that enables the device to send both application and display region inputs to as well as receive scaled output from host 200 over network 305.

Upon completion of the scaling operations performed by the host graphics system responsive to the inputs proved by client device 300, host device 200 may grab the resultant scaled output (e.g., scaled outputs 210, 215 and 220) and then produce data packets which may be compressed by components of host 200 and then sent to client device 300 via data packets through network sockets created within network 305. In one embodiment, data packets may contain pixel data processed by multiple graphics processors 130 within the graphics system of host device 200. Client device 300 may then receive the data packets and proceed to decompress the communication packets received. Client device 200 may then begin to display each scaled output image (e.g., scaled outputs 210, 215 and 220) within their corresponding defined display regions (e.g., display regions 110, 115, and 120 respectively) for display to the user via client device display screen 301.

In one embodiment, host device 200 may be implemented as a data center, server, or virtualized server. Additionally, embodiments of the present invention support host device 200 being implemented as a remote virtual host server that is communicably coupled to a plurality of remote client devices similar to client device 300 over a network (e.g., network 305) and operable to execute multiple instantiations of an application or operating system. Also, client device 300 may be implemented as any device capable of rendering content to a visual display and operable to transmit and receive data over a communication network, such as a mobile device, laptop, desktop computer, or the like. Furthermore, network 305 may be an electronic communications network, including wired and/or wireless communication and including the Internet. Embodiments of the present invention are operable to support conventional network protocol configurations (e.g., UDP, TCP/IP, etc.).

FIG. 4B provides a flow chart of an exemplary method of network communication between a remote client device and a host device implementing a method of scalable resolution display in accordance to embodiments of the present invention. FIG. 4B illustrates how a host device may be operable receive display region input and application input from a remote client device prior to performing scaling operations in accordance with embodiments of the present invention.

At step 501, the display region partitioning module of the host device receives native resolution input from the remote client device over the communication network providing the pixel density of the client device display screen.

At step 502, the host display region partitioning module receives display region input from the remote client device over the communication network providing the coordinates of each display region created by the user within the remote client device's display screen. Using the coordinates provided, the host display region partitioning module determines a pixel density associated with each display region created on the remote client device.

At step 503, the host operating system and/or graphics processor reads the display region input data stored by host display region partitioning module and creates a memory buffer for each display region created at step 502 using the host graphics system.

At step 504, the host graphics driver accesses the coordinate data stored by the host display region partitioning module to map each memory buffer created at step 503 to a corresponding display region created at step 502.

At step 505, the host display region partitioning module receives application input provided by the remote client device over the communication network for a hosted application currently displayed within a display region on the remote client device's display screen.

At step 506, the hosted application receives the application input data provided at step 505 and determines new frame data in response to the input for further processing by the host graphics system.

At step 507, the frame data determined by the hosted application at step 506 is received by the host scaling module. The host scaling module also reads data stored by the host display region partitioning module that provides both the pixel density and coordinates of the display region that the hosted application is currently displayed within on the remote client device.

FIG. 4C presents a flowchart which describes exemplary operations in accordance with the various embodiments herein described. FIG. 4C depicts how embodiments of the present invention are operable to perform scaling operations on frame data received by the host scaling module in accordance with embodiments of the present invention. The details of operation 507 (see FIG. 4B) are outlined in FIG. 4C.

At step 508, the host scaling module calculates a difference between the pixel density of the frame data received at step 507 and the pixel density of the display region read at step 507.

At step 509, a determination is made as to whether the difference calculated at step 508 is within a predetermined density difference range. If the difference is within the predetermined density difference range, then the host scaling module will not perform scaling operations on the frame data, as detailed in step 510. If the difference is not within the predetermined density difference range, then the host scaling module will perform scaling operations on the frame data, as detailed in step 511.

At step 510, the difference is within the predetermined density difference range, therefore, the frame data received at step 507 is placed within its respective memory buffer (determined at step 504) unscaled by the host scaling module.

At step 511, the difference is not within the predetermined density difference range, therefore, the frame data received at step 507 is scaled by the host scaling module with respect to the pixel density and coordinates of the display region that the hosted application is currently displayed within. The host scaling module may adjust the resolution, size, and/or color of the pixel data associated with the frame received.

At step 512, the scaled data produced at step 511 is placed within its respective memory buffer (determined at step 504).

At step 513, data placed within its respective memory buffer is processed by the host graphics processor.

At step 514, the output produced from step 513 is then compressed by the host graphics system and sent to the remote client device via communication packets over the communication network.

At step 515, the remote client device receives the communication packets sent by the host device and proceeds to decompress and render the output images within their corresponding display regions for display to the user via the remote client device's display screen.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of displaying content simultaneously on a single display screen, said method comprising:
accessing a definition of a set of coordinates for each display region of a plurality of display regions located within said single display screen, wherein said single display screen comprises a native resolution value wherein each display region also has a subset resolution value of said native resolution value producing a plurality of subset resolution values, wherein said plurality of subset resolution values comprise at least two different values;
scaling pixel data associated with content for display for each display region of said plurality of display regions producing a scaled output, said scaling using a scaling module; and
rendering said scaled output separately for each display region on said single display screen.

2. The method as described in claim 1, wherein said scaling further comprises:
adjusting said pixel data with respect to said subset resolution value associated with each display region and said set of coordinates associated with said display region.

3. The method as described in claim 2, wherein said plurality of subset resolution values is user-defined.

4. The method as described in claim 1, wherein said plurality of display regions is configured to display different content of a same application within said single display screen.

5. The method as described in claim 1, wherein said plurality of display regions is configured to display different content from different applications within said single display screen.

6. The method as described in claim 1, wherein an application configured to operate using a defined resolution value is operable to automatically launch within a display region of said plurality of display regions upon execution of said application.

7. The method as described in claim 1, wherein said set of coordinates for a given display region is defined subsequent to an execution of an application associated with said given display region.

8. The method as described in claim 1, wherein said single display screen is a high pixel density display screen.

9. A system for displaying content simultaneously on a single display screen, said system comprising:
a display unit coupled to said single display screen, wherein said display unit is operable to display a plurality of display regions on said single display screen, wherein said single display screen comprises a native resolution value;
a coordinate module operable to access a definition of a set of coordinates for each display region of said plurality of display regions within said single display screen and a subset resolution value of said native resolution value for each display region producing a plurality of subset resolution values, wherein said plurality of subset resolution values comprise at least two different values;
a scaling module operable to scale pixel data associated with content for display for each display region of said plurality of display regions producing a scaled output; and
a rendering module operable to render said scaled output separately for each display region on said single display screen.

10. The system as described in claim 9, wherein said scaling module is further operable to adjust said pixel data with respect to said subset resolution value associated with each display region and said set of coordinates associated with said display region.

11. The system as described in claim 10, wherein said plurality of subset resolution values is user-defined.

12. The system as described in claim 9, wherein said plurality of display regions is configured to display different content of a same application within said single display screen.

13. The system as described in claim 9, wherein said plurality of display regions is configured to display different content from different applications within said single display screen.

14. The system as described in claim 9, wherein an application configured to operate using a defined resolution value is operable to automatically launch within a display region of said plurality of display regions upon execution of said application.

15. The system as described in claim 9, wherein said set of coordinates for a given display region is defined subsequent to an execution of an application associated with said given display region.

16. The system as described in claim 9, wherein said single display screen is a high pixel density display screen.

17. A method of displaying content simultaneously on a single display screen coupled to a remote client device, said method comprising:
receiving, from said remote client device over a communication network, a definition of a set of coordinates for each display region of a plurality of display regions located within said single display screen, wherein said single display screen comprises a native resolution value, and a subset resolution value of said native resolution value for each display region producing a plurality of subset resolution values, wherein said plurality of subset resolution values comprise at least two different values;
scaling pixel data associated with content for display for each display region of said plurality of display regions producing a scaled output using a host device; and
using said host device, transmitting said scaled output separately for each display region on said single display screen coupled to said remote client device over said communication network.

18. The method as described in claim 17, wherein said scaling further comprises:
adjusting said pixel data with respect to said subset resolution value associated with each display region and said set of coordinates associated with said display region.

19. The method as described in claim 18, wherein said plurality of subset resolution values is user-defined.

20. The method as described in claim 17, wherein said plurality of display regions is configured to display content of a same application within said single display screen coupled to said remote client device.

21. The method as described in claim 17, wherein said plurality of display regions is configured to display different content from different applications within said single display screen coupled to said remote client device.

22. The method as described in claim 17, wherein an application configured to operate using a defined resolution value is operable to automatically launch within a display region of said plurality of display regions upon execution of said application.

23. The method as described in claim 17, wherein said set of coordinates for a given display region is defined subsequent to an execution of an application associated with said given display region.

24. The method as described in claim 17, wherein said single display screen is a high pixel density display screen.
